(19) United States
(12) Patent Application Publication
(10) Pub. No.: US 2005/0036808 A1
(43) Pub. Date: Feb. 17, 2005

(54) Oil coating roller

(75) Inventor: Isami Abe, Hamamatsu-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: NICHIAS CORPORATION, Tokyo (JP)

(21) Appl. No.: 10/898,226

(22) Filed: Jul. 26, 2004

(30) Foreign Application Priority Data
Aug. 11, 2003 (JP) 2003-291495

(51) Int. Cl. G03G 15/20

(52) U.S. Cl. 399/325

(57) ABSTRACT

An oil coating roller comprising a release agent retaining body formed over the circumference of an axis member to retain a release agent and a release agent coating controlling layer formed over the circumference of the release agent retaining body, the release agent coating controlling layer being a thermoset product of a mixture containing silicone rubber (SG) and silicone oil (SO) at a ratio by weight (SG:SO) of 1:2 to 9:1.

### BACKGROUND OF THE INVENTION

1. Field of the Invention

The present invention relates to an oil coating roller which applies a release agent to the toner fixing part of an electronic copying machine or electrophotographic printing machine.

2. Description of Background Art

In the fixing process of an electrophotographic image-forming apparatus, for example, pressure and heat energy are applied to a toner image using a fixing roller or fixing belt, so that the toner in a semi-solid state is sunk into a sheet of recording paper and fixed. Since the toner is in a semi-solid state when fixed, a part of the semi-solid toner may be transferred to and caused to adhere to the surface of the fixing roller or fixing belt, and the adhering toner may be again transferred to another sheet of recording paper subsequently sent to the fixing roller or fixing belt to stain the image (offset phenomenon). To prevent this offset phenomenon, an oil coating roller applies a release agent such as silicone oil to the surface of the fixing roller or fixing belt coming in contact with the toner in an amount of about 0.1-5.0 mg per sheet of A4 paper.

In recent years, a technology of preventing the offset phenomenon without applying a release agent by using a polymer toner which contains a wax component with a release function has been developed. While this oilless technology has become widely used, there is a problem still to be solved in that the surface of the fixing member is easily abraded and has inferior durability. Therefore, even in the case of employing the oilless technology using a polymer toner, an extremely small amount of oil (about 0.01-0.05 mg per sheet of A4 paper) is applied to the surface of the fixing member to prevent abrasion.

In recent years, a cartridge-type oil coating roller to be replaced when the retained release agent is exhausted is often used to deal with miniaturization of the apparatus. As such a cartridge-type oil coating roller, a roller comprising a nonwoven fabric such as aramid paper as an oil retaining body, which is wound around an axis member and impregnated with a release agent, and an oil coating controlling layer such as porous PTFE formed over the circumference of the nonwoven fabric (Japanese Patent Application Laid-open No. 2000-181259, claim 1) and a roller comprising a felt layer covering the circumference of an oil retaining member and a porous PTFE layer covering the surface of the felt layer (Japanese Patent Application Laid-open No. 2002-102763, claim 4) are known. These oil coating rollers involve high production costs because the production process including the oil impregnating step is complicated, the porous PTFE used in the oil coating controlling layer is expensive, and the ends of the rollers must be designed to have structures to prevent leakage of oil, for example. As an oil coating roller in which the above problems are solved, an oil coating roller of which the main body is a solid elastic body formed from a mixture of a silicone rubber component and an offset preventing liquid is disclosed (Japanese Patent Application Laid-open No. 2001-109308, claim 1). This oil coating roller has a small number of constituent members, involves a simple production process, and therefore can be produced at a low cost.

However, since the main body of the oil coating roller disclosed in Japanese Patent Application Laid-open No. 2001-109308 has both a release agent (oil) retaining function and a release agent (oil) coating controlling function, a large excess amount of the release agent must be used in preparing the mixture of the silicone rubber and the release agent (offset preventing liquid) to be formed; i.e. the ratio of the silicone rubber to the release agent must be 100:400 to 100:2,000. As a result, various problems occur. For example, the amount of oil applied is not constant, in particular, it is impossible to constantly apply an extremely small amount of oil (about 0.01-0.05 mg per sheet of A4 paper), oil is gradually bled onto the surface of the roller when not used (bleeding phenomenon), and sheets are stained with oil in the early paper-passing period.

Accordingly, an object of the present invention is to solve the above problems of these conventional oil coating rollers. Specifically, an object of the present invention is to provide an oil coating roller which does not use an expensive porous PTFE resin, has a simple structure that can simplify the production process, can apply an extremely small and constant amount of a release agent, can surely suppress the bleeding phenomenon, and is inexpensive.

### SUMMARY OF THE INVENTION

In view of this situation, the inventors of the present invention have conducted extensive studies and have found that an oil coating roller which can simplify the production process, can apply an extremely small and constant amount of a release agent, can surely suppress the bleeding phenomenon, and is inexpensive can be obtained by employing a two-layer structure consisting of a release agent retaining body formed over the circumference of an axis member to retain a release agent and a release agent coating controlling layer formed over the circumference of the release agent retaining body, the release agent coating controlling layer being a thermoset product of a mixture containing silicone rubber (SG) and silicone oil (SO) at a ratio by weight (SG:SO) of 1:2 to 9:1. This finding has led to the completion of the present invention.

Specifically, the present invention provides an oil coating roller comprising a release agent retaining body formed over the circumference of an axis member to retain a release agent and a release agent coating controlling layer formed over the circumference of the release agent retaining body, the release agent coating controlling layer being a thermoset product of a mixture containing silicone rubber (SG) and silicone oil (SO) at a ratio by weight (SG:SO) of 1:2 to 9:1.

Since the release agent coating controlling layer is a thermoset product of a mixture containing silicone rubber and silicone oil at a specific ratio, the oil coating roller of the present invention has a simple structure, can be produced at a low cost, and can apply an extremely small and constant amount of a release agent under use conditions. Therefore, an oil coating roller which can be surely suppress the bleeding phenomenon and is inexpensive can be obtained.

### BRIEF DESCRIPTION OF THE DRAWINGS

FIG. 1 is a side view showing the oil coating roller of the present embodiment installed in a fixing device.

FIG. 2 is cross-sectional view in the radial direction showing the oil coating roller of the present embodiment.

FIG. 3 is cross-sectional view in the axial direction showing the oil coating roller of the present embodiment.

FIG. 4 shows the results of evaluation of oil coating characteristics of the oil coating rollers in Examples and Comparative Examples.

### DETAILED DESCRIPTION OF THE INVENTION AND PREFERRED EMBODIMENT

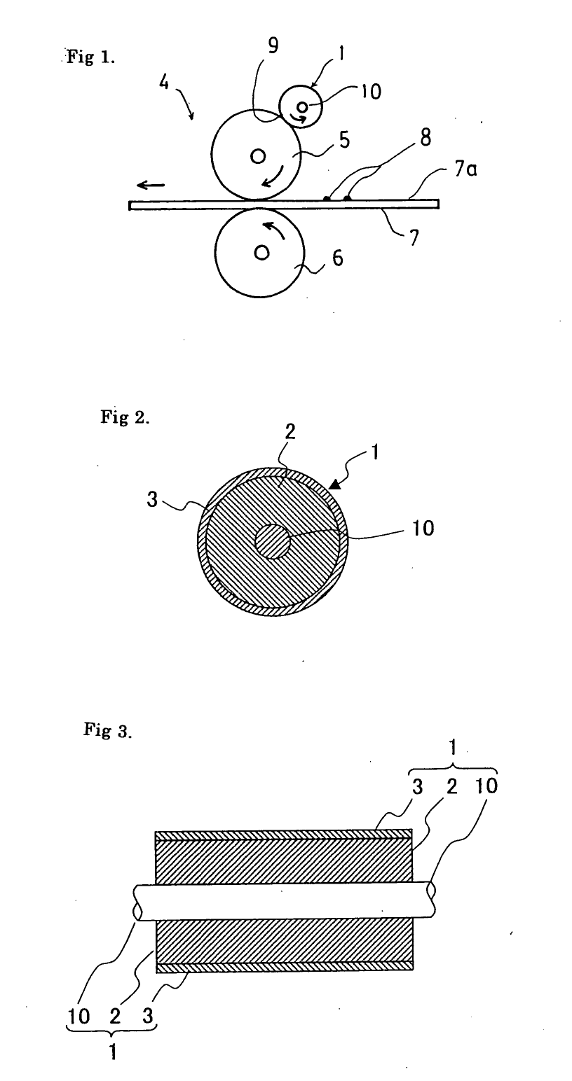

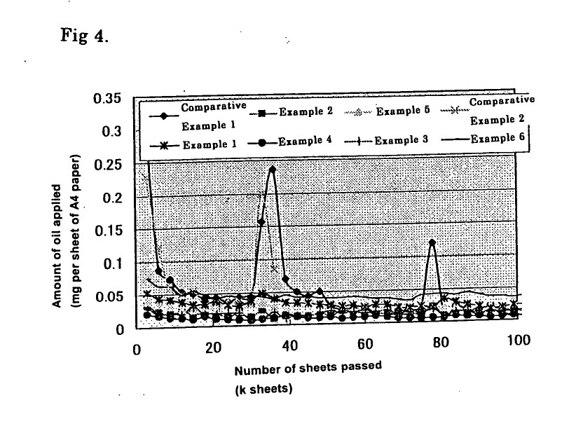

Next, the oil coating roller in an embodiment of the present invention will be described with reference to FIGS. 1-3. FIG. 1 is a side view showing the oil coating roller of the present embodiment installed in a fixing device; FIG. 2 is a cross-sectional view in the radial direction showing the oil coating roller of the present embodiment; and FIG. 3 is a cross-sectional view in the axial direction showing the oil coating roller of the present embodiment. In the figures, an oil coating roller 1 is provided with a release agent retaining body 2 formed over the circumference of an axis member 10 to retain a release agent and a release agent coating controlling layer 3 formed over the circumference of the release agent retaining body 2. The release agent coating controlling layer 3 is a thermoset product of a mixture containing silicone rubber (SG) and silicone oil (SO) at a ratio by weight (SG:SO) of 1:2 to 9:1.

The oil coating roller 1 is incorporated in a fixing device 4. The fixing device 4 causes a sheet of recording paper 7 to pass through the area between a heat fixing roll 5 and a pressing roll 6 to fix toner 8 transferred to the surface 7a of the sheet of recording paper 7. The oil coating roller 1, which is in contact with the heat fixing roll 5 to form a nip 9, applies silicone oil as a release agent to the heat fixing roll 5.

There are no specific limitations to the release agent retaining body 2 insofar as the retaining body 2 can retain a release agent. Examples of the retaining body 2 include a thermoset product of a mixture containing addition reaction-type liquid silicone rubber (SG₁) and a release agent (R) at a ratio by weight (SG₁:R) of 1:4 to 1:1.

The addition reaction-type liquid silicone rubber is crosslinked rubber obtained by adding polymethylsiloxane containing silicon-bonded hydrogen (liquid B) to vinyl-terminated polydimethylsiloxane (liquid A). Although the addition reaction-type liquid silicone rubber usually contains a filler, it is preferable that the addition reaction-type liquid silicone rubber used in the release agent retaining body 2 contain only a small amount of the filler or not contain the filler to smoothly and surely supply the retained release agent to the release agent coating controlling layer 3. Examples of the addition reaction-type liquid silicone rubber include oil bleed rubber “KE1311T” (manufactured by Shin-Etsu Chemical Co., Ltd.) and filler-free rubber “KE106” (manufactured by Shin-Etsu Chemical Co., Ltd.)

There are no specific limitations to the release agent insofar as the release agent can be added to the addition reaction-type liquid silicone rubber and is a liquid that can prevent adhesion of toner. Examples of the release agent include silicone oil, fluorine-modified silicone oil, and a mixture of these. As examples of the silicone oil, straight silicone oil such as dimethyl silicone oil or methyl phenyl silicone oil and modified silicone oil in which some of the dimethyl groups are replaced by other organic groups can be given. Of these, straight silicone oil is preferable due to its miscibility with the addition reaction-type liquid silicone rubber and excellent releasability. The viscosity at 25° C. of the silicone oil is 0.1-10 cm²/s (10-1,000 cSt), and preferably 0.1-3 cm²/s (10-300 cSt).

The thermoset product of a mixture containing addition reaction-type liquid silicone rubber and a release agent, which is the release agent retaining body, can be obtained by heating a mixture containing addition reaction-type liquid silicone rubber (SG₁) and a release agent (R) at a ratio by weight (SG₁:R) of 1:4 to 1:1, and preferably 1:2 to 1:1.5. If the ratio by weight (SG₁:R) is above 1:1, not only does the amount of the release agent retained decrease, requiring frequent replacement of the oil coating roller, but also flexibility of the release agent retaining body is impaired so that a nip cannot be formed, making it difficult to provide the oil coating roller with stable oil coating characteristics. If below 1:4, the release agent retaining body has decreased strength, whereby the oil coating roller easily breaks when removed from a mold or used in practice.

Optional components other than the addition reaction-type liquid silicone rubber and the release agent may be appropriately added to the mixture as the release agent retaining body insofar as performance of the release agent retaining body is not impaired. There are no specific limitations to the heating (curing) conditions. The heating temperature is appropriately determined in the range of 50-150° C., and the heating time is appropriately determined in the range of 15 minutes to two hours.

Since the thermoset product of a mixture containing addition reaction-type liquid silicone rubber and a release agent is a product with a three-dimensional network structure formed by crosslinking of reactive components in the rubber components, the product has excellent oil retaining characteristics, so that the retained oil can coat 300,000 sheets of A4 paper, for example, and can supply an appropriate amount of the release agent to the release agent coating controlling layer. Further, the product can be smoothly removed from a mold because of its moderate hardness and flexibility, and can form a nip during use. Therefore, the product is suitable as the release agent retaining body 2.

The release agent coating controlling layer 3 formed over the circumference of the release agent retaining body 2 further controls the amount to be applied of the release agent seeped from the release agent retaining body 2. The release agent coating controlling layer 3 is a thermoset product of a mixture containing silicone rubber (SG) and silicone oil (SO) at a ratio by weight (SG:SO) of 1:2 to 9:1.

Examples of the silicone rubber used in the release agent coating controlling layer 3 include millable silicone rubber and liquid silicone rubber. As the liquid silicone rubber, addition reaction-type liquid silicone rubber and condensation-type silicone rubber can be given. Of these, addition reaction-type liquid silicone rubber is preferable, because this rubber does not produce a by-product and is cured uniformly from the surface to the inside, so that an excellent product with a three-dimensional network structure can be obtained.

This addition reaction-type liquid silicone rubber is the same as the above addition reaction-type liquid silicone rubber suitably used as the release agent retaining body. However, the addition reaction-type liquid silicone rubber used here preferably contains an inorganic filler, because the filler moderately blocks the fine pores in the three-dimensional network structure, thereby limiting the oil applied to the surface of the fixing member to an extremely small amount (about 0.01-0.05 mg per sheet of A4 paper). As the addition reaction-type liquid silicone rubber containing an inorganic filler, “KE1300” (manufactured by Shin-Etsu Chemical Co., Ltd.) can be used. Although there are no specific limitations to the inorganic filler, a silica filler having an average particle diameter of 0.005-0.2 μm, and particularly preferably 0.01-0.03 μm, can be given as an example.

The silicone oil used in the release agent coating controlling layer 3 forms fine pores, which function as flow paths for the release agent, in the three-dimensional network structure when cured. Therefore, the release agent cannot be applied when using a release agent coating controlling layer made from a thermoset product of silicone rubber not containing silicone oil. Examples of the silicone oil include silicone oil, fluorine-modified silicone oil, and a mixture of these, which are illustrated as the release agent used in the release agent retaining body 2. The silicone oil used in the release agent coating controlling layer 3 and the release agent used in the release agent retaining body 2 are preferably the same compound, despite their different objects of use. Since the silicone oil in the release agent coating controlling layer 3 is first applied to the fixing roller from the release agent coating controlling layer 3 during use, if the same compound is used, uniform and stable application can be achieved in a continuous manner.

The thermoset product of a mixture containing silicone rubber and silicone oil, which is the release agent coating controlling layer 3, is obtained by uniformly applying a mixture containing silicone rubber (SG) and silicone oil (SO) at a ratio by weight (SG:SO) of 1:2 to 9:1, preferably 1:1.5 to 4:1, and particularly preferably 1:1 to 4:1 to the circumference of the release agent retaining body 2 and heating the mixture, for example. If the ratio by weight (SG:SO) is above 9:1, the amount of the silicone oil is too small for fine pores to be formed in the three-dimensional network structure, making it difficult to apply the release agent. If below 1:2, the amount of the release agent applied cannot be controlled. Because of this, a large amount of the release agent is applied to the surface of the fixing member, and the bleeding phenomenon occurs even if the oil coating roller is allowed to stand. It is preferable that the percentage of the silicone rubber (SG) in the total amount of the silicone rubber and the silicone oil (SO) in the release agent coating controlling layer 3 be larger than the percentage of the addition reaction-type liquid silicone rubber (SG₁) in the total amount of the addition reaction-type liquid silicone rubber and the release agent (R) in the release agent retaining body 2. Specifically, the percentage of SG₁ in the total amount of SG₁ and R in the release agent retaining body should be smaller than the percentage of SG in the total amount of SG and SO in the release agent coating controlling layer. This ensures that an extremely small and constant amount of the release agent can be applied and that the cartridge can be replaced at longer intervals because the amount of the release agent retained increases.

There are no specific limitations to the method for uniformly applying the above mixture as the release agent coating controlling layer 3 to the circumference of the release agent retaining body 2. Any conventional method such as a brush coating method, dipping method, and roll coating method can be used. As the amount of the mixture applied to the circumference of the release agent retaining body 2, 1.5-2.5 mg/cm² is sufficient. Even such a thin coating layer can sufficiently control application of the release agent. The upper limit of the amount of the release agent applied is about 5.0 mg/cm², but is not limited thereto. Too large an amount of the release agent cannot improve performance of the release agent coating controlling layer 3 to a degree proportionate to such an amount, but only results in an increase in the production cost. Optional components other than the silicone rubber and the silicone oil may be appropriately added to the mixture as the release agent coating controlling layer 3 insofar as performance of the release agent coating controlling layer is not impaired. There are no specific limitations to the heating (curing) conditions as in the case of the release agent retaining body 2. The heating temperature is appropriately determined in the range of 50-150° C., and the heating time is appropriately determined in the range of 15 minutes to two hours.

The thermoset product of a mixture containing silicone rubber and silicone oil controls the release agent seeped from the release agent retaining body. An extremely small and constant amount of the oil (about 0.01-0.05 mg per sheet of A4 paper) can be applied to the surface of the fixing member. The release agent does not leak from the release agent coating controlling layer. In addition, since the release agent coating controlling layer can be formed on the surface of the release agent retaining body in only the application step, the production process can be simplified.

In the oil coating roller 1 of the present embodiment, when a mixture containing addition reaction-type liquid silicone rubber and a release agent is cured with heat to produce a thermoset product as the release agent retaining body 2, the releasing agent is incorporated in the crosslinked rubber. An appropriate amount of the release agent is seeped from the surface of the release agent retaining body 2 by heat, external stress, diffusion phenomenon for making the viscosity of the release agent uniform, or the like. The release agent coating controlling layer 3 further controls the amount to be applied of the release agent seeped from the release agent retaining body. When the release agent coating controlling layer 3 contains addition reaction-type liquid silicone rubber containing a silica filler with a particle diameter of, in particular, 0.01-0.2 μm, the silica filler blocks the fine pores in the crosslinked rubber to more surely suppress migration of the silicone oil.

### EXAMPLES

The present invention will be described in more detail by examples, which should not be construed as limiting the present invention.

### Example 1

A solid axis member with an external diameter of 8 mm was placed on the center of a hollow mold with a diameter of 16 mm and a length of 304 mm. Next, a liquid mixture prepared by mixing filler-free addition reaction-type liquid silicone rubber “KE1311T” (manufactured by Shin-Etsu Chemical Co., Ltd.) with a release agent “dimethyl silicone oil KF96-100cs” (manufactured by Shin-Etsu Chemical Co., Ltd.) at a ratio by weight of 20:80 was cast in the mold. The mold was put in a drier at 70° C. for one hour to crosslink the rubber, followed by demolding to obtain a release agent retaining body. Then, a liquid mixture prepared by mixing addition reaction-type liquid silicone rubber “KE1300” containing a silica filler with a particle diameter of 0.02 μm with dimethyl silicone oil “KF96-100cs” (manufactured by Shin-Etsu Chemical Co., Ltd.) at a ratio by weight of 80:20 was applied to the circumference of the release agent retaining body in an amount of 1.5-2.5 mg/cm² using a roll coater. The body was put in a drier at 70° C. for one hour to cure the coating layer, thereby forming a release agent coating controlling layer. An oil coating roller A was thus obtained. The oil coating roller A was evaluated in the following evaluation tests (1)-(4). The results are shown in Table 1. The oil coating characteristics are shown in the graph (FIG. 1) for ease of understanding.

(Evaluation Test (1): Surface Bleeding)

The oil coating roller was allowed to stand at room temperature for 20 days to measure the amount of oil bled from the surface of the roller.

(Evaluation Test (2): Oil Coating Characteristics)

The oil coating roller was mounted on a fixing device (fixing temperature: 170° C.) installed in a commercially available color printer (paper-passing speed for color printing: 60 sheets/min). The weight of the oil coating roller was measured each time 3,000 sheets were passed through the fixing device to calculate the amount of oil applied to a sheet of A4 paper.

(Evaluation Test (3): Demolding Characteristics)

When demolding to obtain the release agent retaining body, the degree of occurrence of cracks in the release agent retaining body was visually observed. The case where no cracks were produced and excellent demolding was carried out was evaluated as “good”.

(Evaluation Test (4): Flexibility)

The hardness of the oil coating roller was measured using an Asker C hardness tester. A roller with a hardness of 6-20 was indicated as “good”, a roller with a hardness of 21-30 was indicated as “somewhat hard”, and a roller with a hardness of 1-5 was indicated as “somewhat soft”. A roller with a “good” hardness formed an appropriate nip during use.

### Example 2

An oil coating roller B was obtained in the same manner as in Example 1, except that the ratio of the addition reaction-type liquid silicone rubber to the release agent in the release agent retaining body was changed to 30:70 from 20:80.

### Example 3

An oil coating roller C was obtained in the same manner as in Example 1, except that the ratio of the addition reaction-type liquid silicone rubber to the release agent in the release agent retaining body was changed to 40:60 from 20:80.

### Example 4

An oil coating roller D was obtained in the same manner as in Example 1, except that the ratio of the addition reaction-type liquid silicone rubber to the release agent in the release agent retaining body was changed to 50:50 from 20:80.

### Example 5

An oil coating roller E was obtained in the same manner as in Example 1, except that the ratio of the addition reaction-type liquid silicone rubber to the dimethyl silicone oil in the release agent coating controlling layer was changed to 60:40 from 80:20.

### Example 6

An oil coating roller F was obtained in the same manner as in Example 1, except that the ratio of the addition reaction-type liquid silicone rubber to the dimethyl silicone oil in the release agent coating controlling layer was changed to 40:60 from 80:20. Specifically, in the oil coating roller F of Example 6, the amount of the dimethyl silicone oil is larger than the amount of the addition reaction-type liquid silicone rubber in the release agent coating controlling layer, and the percentage of the addition reaction-type liquid silicone rubber in the mixture which is the release agent coating controlling layer is larger than the percentage of the addition reaction-type liquid silicone rubber in the mixture which is the release agent retaining body.

### Comparative Example 1

An oil coating roller G was obtained in the same manner as in Example 2, except that a release agent coating controlling layer was not provided.

### Comparative Example 2

An oil coating roller H was obtained in the same manner as in Example 2, except that the ratio of the addition reaction-type liquid silicone rubber to the dimethyl silicone oil in the release agent coating controlling layer was changed to 30:70 from 80:20.

TABLE 1

| | | | | | | | | | G | H |
|---|---|---|---|---|---|---|---|---|---|---|
| | | Sample No. | A | B | C | D | E | F | Comparative | Comparative |
| | | Raw material | Example 1 | Example 2 | Example 3 | Example 4 | Example 5 | Example 6 | Example 1 | Example 2 |
| Oil retaining | Rubber | KE1311 | 20 | 30 | 40 | 50 | 30 | 30 | 30 | 30 |
| part | Release | KF96-100cs | 80 | 70 | 60 | 50 | 70 | 70 | 70 | 70 |
| | agent | | | | | | | | | |
| Oil coating | Rubber | KE1300 | 80 | 80 | 80 | 80 | 60 | 40 | — | 30 |
| controlling | Release | KF96-100cs | 20 | 20 | 20 | 20 | 40 | 60 | — | 70 |
| layer | agent | | | | | | | | | |

| | Days of allowing oil | | | | | | | Comparative | Comparative |
|---|---|---|---|---|---|---|---|---|---|
| Test 1 | coating roller to stand | Example 1 | Example 2 | Example 3 | Example 4 | Example 5 | Example 6 | Example 1 | Example 2 |
| Amount of release | 1 | 0.0 | 0.0 | 0.0 | 0.0 | 0.0 | 0.0 | 1.2 | 0.3 |
| agent bled onto the | 2 | 0.0 | 0.0 | 0.0 | 0.0 | 0.0 | 0.1 | 1.8 | 0.7 |
| surface of oil coating | 3 | 0.0 | 0.0 | 0.0 | 0.0 | 0.0 | 0.1 | 2.4 | 1.0 |
| roller when allowed to | 4 | 0.0 | 0.0 | 0.0 | 0.0 | 0.0 | 0.2 | 2.9 | 1.4 |
| stand (mg/mm²) | 5 | 0.0 | 0.0 | 0.0 | 0.0 | 0.0 | 0.3 | 3.5 | 1.8 |
| | 10 | 0.0 | 0.0 | 0.0 | 0.0 | 0.0 | 0.5 | 5.6 | 3.1 |
| | 20 | 0.0 | 0.0 | 0.0 | 0.0 | 0.0 | 0.6 | 8.3 | 5.3 |
| | Number of sheets passed | | | | | | | Comparative | Comparative |
| Test 2 | (k sheets) | Example 1 | Example 2 | Example 3 | Example 4 | Example 5 | Example 6 | Example 1 | Example 2 |
| Amount of oil applied | 3 | 0.05 | 0.03 | 0.03 | 0.02 | 0.04 | 0.08 | 0.31 | 0.23 |
| (mg per sheet of A4 | 6 | 0.04 | 0.02 | 0.02 | 0.02 | 0.04 | 0.06 | 0.09 | 0.12 |
| paper) | 9 | 0.04 | 0.02 | 0.02 | 0.01 | 0.03 | 0.06 | 0.07 | 0.06 |
| | 12 | 0.04 | 0.02 | 0.02 | 0.01 | 0.03 | 0.05 | 0.05 | 0.05 |
| | 15 | 0.03 | 0.02 | 0.03 | 0.01 | 0.03 | 0.06 | 0.05 | 0.06 |
| | 18 | 0.03 | 0.02 | 0.02 | 0.02 | 0.03 | 0.05 | 0.04 | 0.03 |
| | 21 | 0.04 | 0.02 | 0.02 | 0.01 | 0.03 | 0.04 | 0.04 | 0.04 |
| | 24 | 0.03 | 0.01 | 0.02 | 0.01 | 0.04 | 0.05 | 0.04 | 0.03 |
| | 27 | 0.03 | 0.02 | 0.02 | 0.01 | 0.02 | 0.04 | 0.04 | 0.04 |
| | 30 | 0.04 | 0.01 | 0.01 | 0.01 | 0.03 | 0.05 | 0.04 | 0.03 |
| | 33 | 0.05 | 0.02 | 0.01 | 0.01 | 0.03 | 0.04 | 0.16 | 0.20 |
| | 36 | 0.04 | 0.01 | 0.02 | 0.01 | 0.03 | 0.04 | 0.24 | 0.09 |
| | 39 | 0.03 | 0.02 | 0.01 | 0.02 | 0.03 | 0.05 | 0.07 | |
| | 42 | 0.03 | 0.01 | 0.02 | 0.01 | 0.03 | 0.04 | 0.05 | |
| | 45 | 0.03 | 0.01 | 0.01 | 0.01 | 0.03 | 0.04 | 0.04 | |
| | 48 | 0.03 | 0.02 | 0.02 | 0.01 | 0.03 | 0.04 | 0.05 | |
| | 51 | 0.03 | 0.01 | 0.02 | 0.01 | 0.03 | 0.04 | 0.03 | |
| | 54 | 0.03 | 0.02 | 0.02 | 0.01 | 0.03 | 0.04 | 0.02 | |
| | 57 | 0.03 | 0.02 | 0.02 | 0.01 | 0.03 | 0.04 | 0.02 | |
| | 60 | 0.03 | 0.02 | 0.02 | 0.01 | 0.02 | 0.04 | 0.02 | |
| | 63 | 0.03 | 0.02 | 0.02 | 0.01 | 0.03 | 0.04 | 0.02 | |
| | 66 | 0.03 | 0.01 | 0.02 | 0.01 | 0.03 | 0.04 | 0.01 | |
| | 69 | 0.02 | 0.02 | 0.01 | 0.01 | 0.03 | 0.04 | 0.01 | |
| | 72 | 0.02 | 0.02 | 0.01 | 0.01 | 0.02 | 0.03 | 0.02 | |
| | 75 | 0.03 | 0.01 | 0.01 | 0.01 | 0.03 | 0.04 | 0.02 | |
| | 78 | 0.02 | 0.02 | 0.02 | 0.01 | 0.02 | 0.04 | 0.12 | |
| | 81 | 0.04 | 0.01 | 0.01 | 0.01 | 0.02 | 0.04 | 0.01 | |
| | 84 | 0.03 | 0.02 | 0.02 | 0.01 | 0.02 | 0.04 | 0.02 | |
| | 87 | 0.03 | 0.02 | 0.02 | 0.01 | 0.03 | 0.05 | 0.02 | |
| | 90 | 0.02 | 0.02 | 0.01 | 0.01 | 0.03 | 0.04 | 0.01 | |
| | 93 | 0.02 | 0.02 | 0.01 | 0.01 | 0.02 | 0.04 | 0.02 | |
| | 96 | 0.02 | 0.02 | 0.02 | 0.01 | 0.02 | 0.04 | 0.01 | |
| | 99 | 0.02 | 0.02 | 0.02 | 0.01 | 0.03 | 0.04 | 0.01 | |
| | 102 | 0.03 | 0.02 | 0.01 | 0.01 | 0.02 | 0.04 | 0.01 | |
| Demolding | Strength | Somewhat | Good | Good | Good | Good | Good | Good | Good |
| characteristics | | low | | | | | | | |
| Flexibility evaluation | Hardness | Somewhat | Good | Good | Somewhat | Good | Good | Good | Good |
| | | soft | | | hard | | | | |

As is clear from Table 1, the release agent was not bled from the surface of the oil coating rollers of Examples 1-5 when allowed to stand at room temperature for 20 days. Only an extremely small amount of the release agent was bled from the surface of the oil coating roller of Example 6. On the other hand, a considerably large amount of the release agent was bled from the surface of the oil coating rollers of Comparative Examples 1 and 2. The amount was 5-8 mg/mm² on the 20th day. In the oil coating rollers of Examples 1-6, the amount of the oil applied was 0.01-0.05 mg per sheet of A4 paper, which was almost the target amount. The amount of the release agent applied was very constant. On the other hand, in the oil coating rollers of Comparative Examples 1 and 2, the amount of the release agent applied was large in the early period. The amount of the release agent applied was not constant. The test for the oil coating roller of Comparative Example 2 was terminated when 36k (36,000) sheets were passed through the fixing device because of the poor evaluation results.

The oil coating roller of the present embodiment (1) causes no leakage of the release agent when vertically placed; (2) causes no bleeding of the release agent when allowed to stand for a long period of time and, therefore, causes no problem in the early paper-passing period; (3) can apply a small and very constant amount of oil and, therefore, can reduce surface abrasion of the fixing belt or fixing roller for a long period of time; and (4) has a simple structure and, therefore, can be produced in a simple process at a low cost.

1. An oil coating roller comprising a release agent retaining body formed over the circumference of an axis member to retain a release agent and a release agent coating controlling layer formed over the circumference of the release agent retaining body, the release agent coating controlling layer being a thermoset product of a mixture containing silicone rubber (SG) and silicone oil (SO) at a ratio by weight (SG:SO) of 1:2 to 9:1.

2. The oil coating roller according to claim 1, wherein the silicone rubber is addition reaction-type liquid silicone rubber.

3. The oil coating roller according to claim 1, wherein the silicone rubber contains an inorganic filler.

4. The oil coating roller according to claim 3, wherein the inorganic filler is a silica filler with an average particle diameter of 0.005-0.2 μm.

5. The oil coating roller according to claim 1, wherein the release agent and the silicone oil are the same compound.

6. The oil coating roller according to claim 1, wherein the release agent retaining body is a thermoset product of a mixture containing addition reaction-type liquid silicone rubber (SG₁) and a release agent (R) at a ratio by weight (SG₁:R) of 1:4 to 1:1, and the percentage of SG₁ in the total amount of SG₁ and R is equal to or lower than the percentage of SG in the total amount of SG and SO in the release agent coating controlling layer.

7. The oil coating roller according to claim 1, wherein the release agent coating controlling layer is a coating film formed over the circumference of the cylindrical release agent retaining body.
